(19) United States
(12) Patent Application Publication
(10) Pub. No.: US 2023/0379285 A1
(43) Pub. Date: Nov. 23, 2023

(54) SYNCHRONIZED CONVERSATION SPACE COMMANDS IN A SOCIAL MESSAGING PLATFORM

(71) Applicant: Twitter, Inc., San Francisco, CA (US)

(72) Inventor: Richard Plom, San Francisco, CA (US)

(21) Appl. No.: 17/750,192

(22) Filed: May 20, 2022

(51) Int. Cl. H04L 51/48; G06F 3/16; G06F 3/0485

(52) U.S. Cl. CPC H04L 51/48; G06F 3/165; G06F 3/0485

(57) ABSTRACT

Methods, systems, and apparatus, including computer programs encoded on a computer storage medium, in which a host client that has joined an conversation space within a social messaging platform receives user input; generates from the user input data representing a user input command to be executed by other user devices; and provides the data representing the user input command to the social messaging platform. The social messaging platform can provide second data representing the user input command to other user devices that have joined the conversation space. A client on a second user device can receive the data representing the user input command and a mixed audio stream, and render and output the mixed audio stream. That client can execute the user input command at the later of (i) the time location relative to the mixed audio stream, or (ii) when the second user device receives the second data.

### BACKGROUND

This specification relates to social messaging platforms, and in particular, to synchronizing application commands in a conversation space of a social messaging platform.

Social messaging platforms and network-connected personal computing devices allow users to create and share content across multiple devices in real-time. Sophisticated mobile computing devices, e.g., smartphones, tablets and smart watches, make it easy and convenient for people, companies, and other entities to use social messaging platforms and applications. Popular social messaging platforms generally provide functionality for users to have audio conversations and chats with other users of the platform.

As one example, a conversation space is a dynamic, social media venue that can be created by one member of the social messaging platform, the “host,” and joined by other users of the platform. Users can participate in the conversation space by speaking in the conversation space, listening to the conversation in the conversation space, or submitting non-audio content, e.g., text, social messaging posts, images, videos, emoji, or stickers, to the conversation space. The host of the conversation space can control access to and participation in the conversation space, and recordings of the conversation space can typically be accessed only by the host and only for a limited time after the conversation space has been closed.

### SUMMARY

In general, innovative aspects of the subject matter described in this specification relate to mirroring the experience of a host device to one or more other user devices participating in an audio conversation space. To do so, the system can synchronize a command issued at the host device to a particular location within an audio stream recorded at the host device. Then, when the audio stream is played by other user devices participating in the conversation space, corresponding commands can be automatically issued by the other user devices into the application software such that the issuance of the commands at the other devices remains synchronized with the audio stream recorded at the host device. This synchronization mirrors the experience of the host device by effectively allowing participants in the conversation space to see and hear what the host is describing in synchronization with what the host is doing on the host device. Therefore, other user devices in a conversation space can effectively have activity at the host device mirrored on their devices but without the bandwidth overhead and latency expense of screen sharing or transmitting video streams. In this specification, a mirrored stream of content refers to an audio stream and at least one command that has a corresponding location within the audio stream.

This functionality also provides for low-bandwidth replay of commands issued at the host device. This allows other users to experience the commands synchronized to the audio recorded at the host device, but later in time. Therefore, while the commands issued at the host device and at the other devices might be effectively synchronized in time by happening at substantially the same time or within a few seconds of each other, the commands can also be issued at the other devices much later on while still being synchronized to particular locations within the audio stream.

In this specification, a conversation space is an interface that includes visual components (e.g., text, video, user interface elements such as button and links, etc.) and is hosted on a social messaging platform for users of the platform to participate in a shared audio conversation. Conversation spaces remain may open for participation for a limited amount of time.

Social messaging platforms often generate and provide message streams. A message stream can include a series of event records, e.g., messages or images, posted to a social messaging platform. Display of the event records can be ordered, for example, by time received, by subject, by popularity, or by other criteria. Popularity can be indicated, for example, by the number of views, followers, likes, or other user engagements.

Access to a message stream can be public—that is, viewable by all members of a social messaging platform—or restricted. A restricted message stream can be accessed only by an authorized subset of members of a social messaging platform.

Particular embodiments of the subject matter described in this specification can be implemented so as to realize one or more of the following advantages. The techniques described in this specification can synchronize an interaction with a message stream to an audio stream of a conversation space in order to replicate the interaction across user devices associated with a conversation space. This provides a bandwidth-efficient way for users in a conversation space to share experiences. Rather than needing to stream video, commands being synchronized with an audio stream of a host device effectively recreates the experience at other user devices taking part in the conversation space. This allows the system to provide a mirrored experience without the need to transmit video data, thereby reducing the network burden and increasing scalability. Moreover, the experience can be recreated at the other devices without the drawbacks of lossy video compression, resulting in a lossless sharing of experiences at low bandwidth.

In addition, the techniques described below can be used to provide a mixed audio stream that includes audio signals received from the user devices in the audio conversation space while also mirroring the streams of content. This enables a user on a host client running on a host device to provide audio data, including spoken audio, that is supplemented by or complements information on the mirrored stream of content. In addition, the techniques described below can be used to synchronize the execution of commands and audio at a client device based on the timing of their occurrence on the host device.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of a platform for providing mirrored streams of content to users of a conversation space using a social messaging platform.

FIG. 2A is a flow diagram of a process for synchronizing initial state in a platform for providing synchronized streams of content to users of a conversation space using a social messaging platform.

FIG. 2B is a flow diagram of a process for registering client devices in a platform for providing synchronized streams of content to users of a conversation space using a social messaging platform.

FIG. 2C is a flow diagram of a process for providing synchronized streams of content to users of a conversation space using a social messaging platform.

FIG. 2D is a flow diagram of a process for providing synchronized streams of content with mixed audio streams in a platform for providing synchronized streams of content to users of a conversation space using a social messaging platform.

FIG. 3 is a flow diagram of altering the host in a platform for providing synchronized streams of content to users of a conversation space using a social messaging platform.

Like reference numbers and designations in the various drawings indicate like elements.

### DETAILED DESCRIPTION

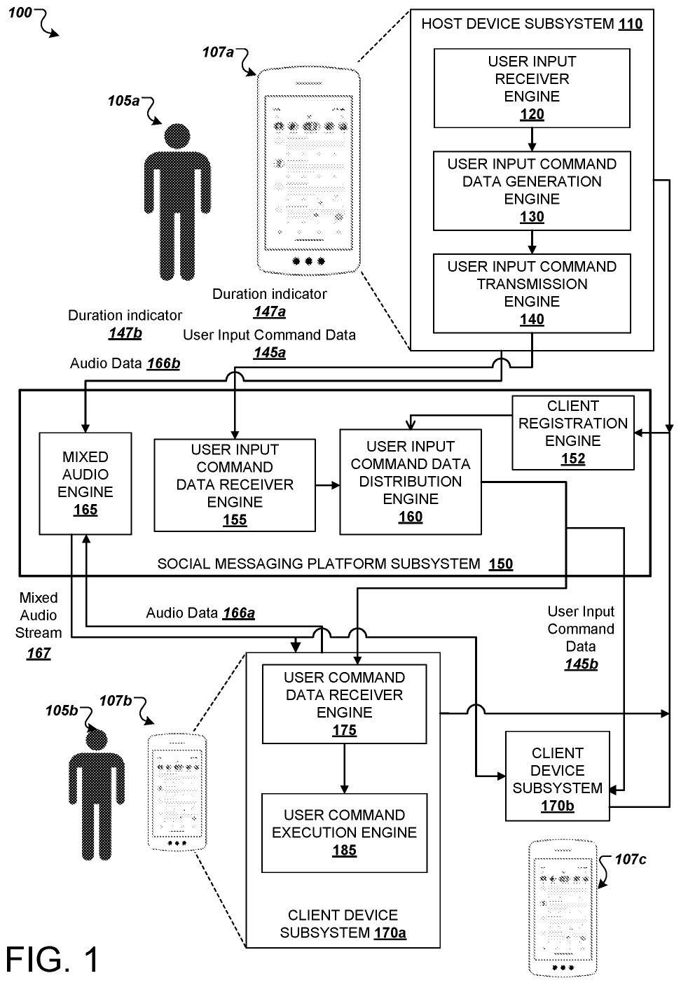

FIG. 1 is a diagram of a platform for providing mirrored streams of content to users participating in a conversation space using a social messaging platform. This effectively allows users to discuss and share experiences using the social messaging platform without requiring streamed video.

The social messaging platform subsystem 150 can provide streams of content to user devices that meet one or more stream criteria. A stream can be defined by the stream criteria to include content posted by one or more accounts. For example, the contents of a stream for a requesting account holder may include one or more of (i) content composed by that account holder, (ii) content composed by the other accounts that the requested account holder follows, (iii) content authored by other accounts that reference the requested account holder, or (iv) content sponsored by third parties for inclusion in the account holder's message stream. The content of a stream may be ordered chronologically by time and date of authorship, or reverse chronologically. Streams may also be ordered in other ways, e.g., according to a computationally predicted relevance to the account holder, or according to some combination of time and relevance score.

A stream may potentially include a large volume of content. For both processing efficiency and the requesting account holder's viewing convenience, the platform generally identifies a subset of the content meeting the stream criteria to send to a requesting client once the stream is generated. The remainder of the content in the stream is maintained in a stream repository and can be accessed upon client request.

Conversation spaces provide a convenient venue for audio-focused social interaction among users of a social messaging platform. Conversation spaces enable users to quickly and easily join and participate in audio interactions. For example, invitations to join an active audio space conversation can be automatically provided to users of the platform that are followers of the user hosting the conversation space. Similarly, invitations to join an active conversation can be automatically provided to the followers of each user that has joined the audio conversation space as a speaker. Followers of the host and/or speakers of the conversation space can be automatically alerted when a conversation space is initiated and can easily join and participate in the conversation. Recordings of the conversations held within the conversation space can have a limited lifetime and access to recordings of the conversation can be restricted to the host of the audio conversation space, protecting the privacy of participants in the conversation space.

Conversation spaces with mirrored streams of content can be especially convenient for presentation-like conversations where a host provides audio content and one or more commands to be issued by application software installed on other devices participating in the conversation space. For example, a teacher might use a conversation space to present material to a group of students by scrolling to various content items within a message stream while also providing audio data, e.g., recorded voice data, describing each of the content items. The scroll commands can be synchronized to the audio stream and then issued by the other devices at corresponding points as the audio stream is played back.

Returning to FIG. 1, the platform for providing mirrored streams of content can include a host device subsystem 110, a social messaging platform subsystem 150, and one or more client device subsystems 170a, 170b.

The host device subsystem 110 can be executed by a user's 105a computing device 107a, e.g., a mobile phone or a tablet computer. The host device subsystem 110 can include a user input receiver engine 120, a user input command data generation engine 130 and a user input command data transmission engine 140.

The user input receiver engine 120 can receive indications of user input commands representing user interactions, e.g., swipes, presses, long presses, taps, mouse clicks, key presses, voice input, text input and so on, provided by a user 105a to a user device 107a. The user input receiver engine 120 can also receive additional information about the user interaction, which can include the location and duration of a press, and the length and speed of a swipe.

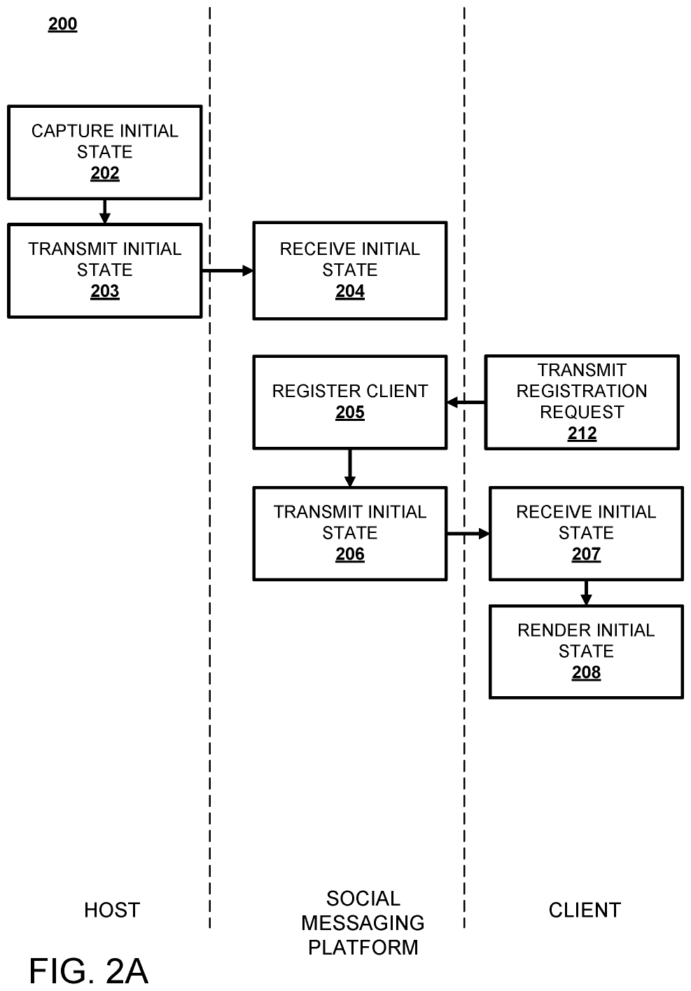

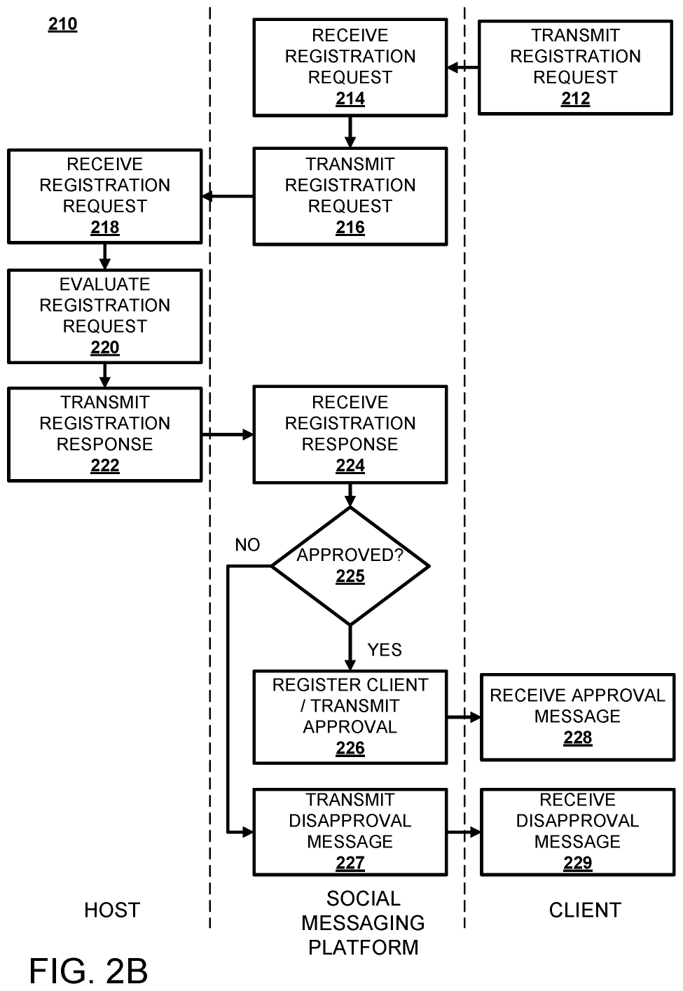

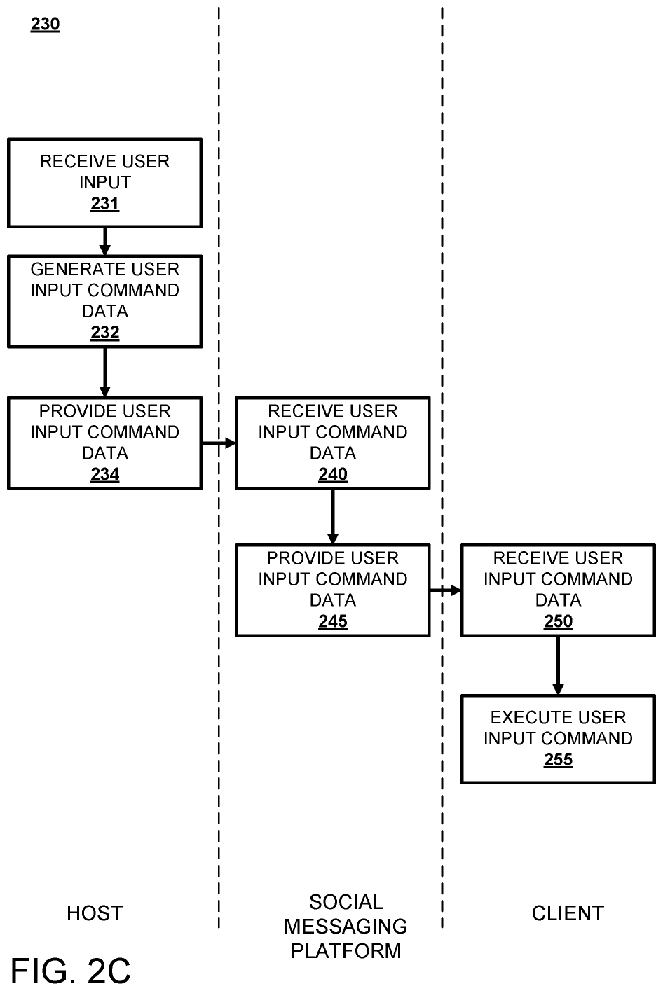

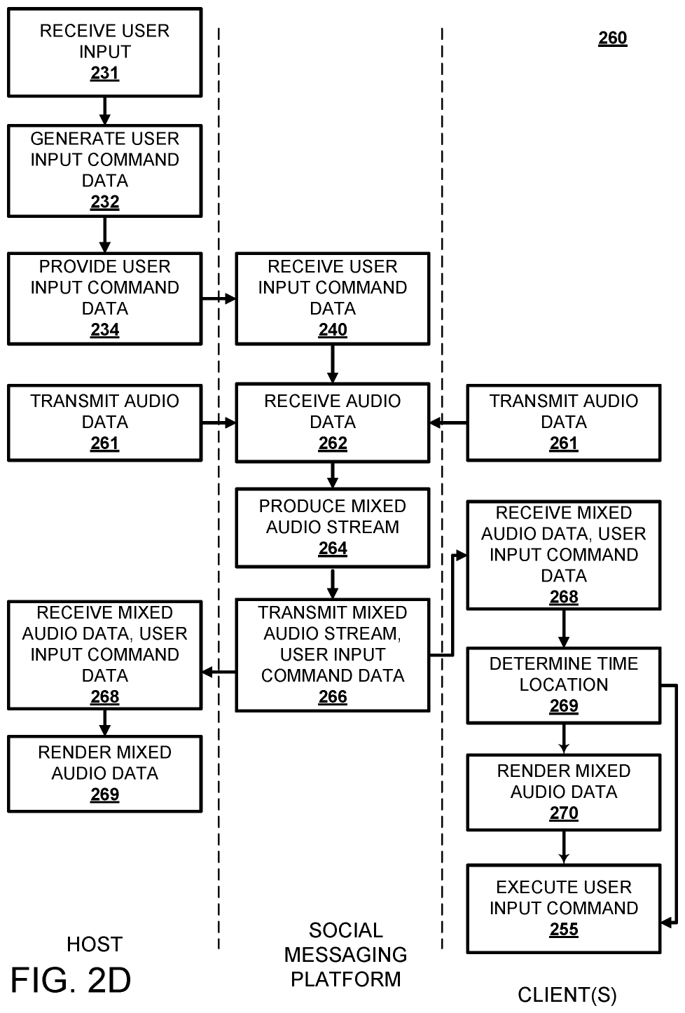

The user input command data generation engine 130 can associate an indication of a user interaction on a user device with a user command. The user input command data generation engine can determine the action that corresponds to the user action as described further in reference to FIG. 2. The user input command data generation engine can create user input command data that describes the action.

The user input command data can represent a user input command. Alternatively or in addition, the user input command data can represent a result of the command. Examples of results can include advancing to a particular entry in a stream of content, causing audio or video content to play, rendering content on a display, and so on. Additional examples can include switching to the stream of content of a particular social messaging platform user, scrolling a given number of entries or going to a specific position. Examples of commands required to achieve a result can include a press action for a specific duration at a specific location.

The user input command data can be represented as a descriptor of the command or the result of the command. For example, a descriptor indicating that a stream of content entry is to be displayed, might be represented as “display stream of content N”, where N is an indicator of the stream of content entry. The input command data can be represented as a binary code or in text, e.g., in Extensible Markup Language (XML), as follows “<Action><Stream of contentDisplay>N</Stream of contentDisplay”></Action>.” The XML schema can contain entries for other action types, e.g., switching users or swiping for a length at a speed.

Importantly, representations of commands will be substantially smaller than a corresponding video stream, significantly reducing the bandwidth required to mirror streams of content in the communication space as compared to streaming video. Descriptive representations, e.g., XML commands or JavaScript Object Notation (JSON), can be expressed in tens of hundreds of bytes of data, while a video stream, even optimally compressed, requires substantially more data. Using descriptive representations therefore reduces the required network bandwidth and increases scalability.

The user input command data transmission engine 140 can transmit user input command data 145a to the social messaging platform subsystem 150 using any appropriate networking protocol, e.g., Hypertext Transfer Protocol (HTTP), Transmission Control Protocol/Internet Protocol (TCP/IP) or User Datagram Protocol (UDP).

Optionally, the host device subsystem 110 can transmit registration indications to the client registration engine 152 of the social messaging platform subsystem 150 to enroll client device subsystems 170a, 170b in a conversation space.

The social messaging platform subsystem 150 can accept user input command data 145a from the host device subsystem 110, and transmit the user input command data 145b to one or more client device subsystems 170a, 170b. The social messaging platform 150 can also transmit additional information, e.g., message posts, images, emojis, etc., received from the host device 107a or from another device, e.g., the client device 107b. The social messaging platform subsystem 150 can include a client registration engine 152, a user input command receiver engine 155, a user input command distribution engine 160 and a mixed audio engine 165.

The client registration engine 152 can accept client registration requests from the host device subsystem 110 and/or from one or more client device subsystems 170a, 170b. The client registration request can include an indication of the client device subsystem 170a, 170b that is being registered. The client registration engine 152 can maintain a record for each client device subsystem 170a, 170b registered to the communication space. The client registration engine 152 can maintain the records in any appropriate storage format, e.g., in a database or in a file in a file system.

Optionally, the client registration engine 152, upon receiving a client registration request from a client device subsystem 170a, 170b can require approval from the host device subsystem 110 before enrolling the client device subsystem. In such cases, as described in more detail below with reference to FIG. 2B, the client registration engine 152 can transmit a request that includes an indicator of the client device subsystem to the host device subsystem 110. If the client registration engine 152 receives an approval message from the host device subsystem 110, the client registration engine 152 enrolls the client device subsystem in the communication space.

The user input command data receiver engine 155 can receive the user input command data using the protocol selected by the user input command data transmission engine 140, e.g., HTTP, TCP/IP or UDP, to name just a few examples.

The user input command data distribution engine 160 can retrieve from the client registration engine 162 the list of client device subsystems 170a, 170b registered to the communication space, and transmit the user command data to those client device subsystems 170a, 170b using a point-to-point networking protocol e.g., HTTP, TCP/IP or UDP, or using a multicast protocol, e.g., Internet Group Management Protocol, Protocol Independent Multicast and Multicast VLAN Registration. The mixed audio engine 165 can receive audio data 166a, 166b that includes audio signals received from the host device 107a and from user devices 107b,c enrolled in the conversation space, and distribute the mixed audio stream 167 to the user devices. The mixed audio engine 165 can receive audio data 166a, 166b using a networking protocol, e.g., HTTP, TCP/IP or UDP. The mixed audio engine 165 can send mixed audio streams 167 using a point-to-point networking protocol, e.g., HTTP, TCP/IP or UDP or using a multicast protocol as described above.

The client device subsystem 170a, 170b can accept user input command data 145b from a social messaging platform subsystem 150 and execute the commands indicated by the user input command data 145b. The client device subsystem 170a, 170b can include a user command receiver engine 175 and a user command execution engine 185.

A user command data receiver engine 175 can receive the user input command data using the protocol selected by the user input command data distribution engine 160 as described above.

A user command execution engine 185 can execute the command indicated by the user input command data 146b on a user's 105b client device 107b, 107c. As described above, the user input command data can be encoded as XML, and the user command execution engine 185 can parse the XML using convention XML parsing techniques. The user command execution engine 185 can execute a corresponding command on the client device by invoking an application programming interface (API) provided, for example, by the client device, the client device subsystem or both.

The client device subsystem 170a, 170b can also transmit audio data 166a to the mixed audio engine 165 in the social messaging platform subsystem 150, and receive a mixed audio stream 167 from the mixed audio engine 165. The client device subsystem 170a, 170b can render the mixed audio stream 167 on a client device 107a, 107b.

Like the client device subsystem 170a, the host device subsystem 110 can transmit audio data 166b to the mixed audio engine 165 in the social messaging platform subsystem 150. The host device subsystem 110 can associate a duration indicator 147b with the audio data 166b, as described further below. In addition, the host device subsystem 110 can associate a source indicator that specifies that the audio data 166b was generated by the host device 107a. The source indicator can be, for example, a Boolean or an integer value. For example, the source indicator can be a Boolean that is set to FALSE by default, indicating that the source was a client device, and set to TRUE if the audio data 166b is produced by the host device subsystem 110. In another example, the source indicator can be set to the number 0 by default, indicating that the source was a client device, and set to 1 if the audio data 166b is produced by the host device subsystem 110.

FIG. 2A is a flow diagram of a process for synchronizing initial state in a platform for providing mirrored streams of content to users of a conversation space using a social messaging platform. For convenience, the process 200 will be described as being performed by a system of one or more computers located in one or more locations. For example, a platform for providing mirrored streams of content, e.g., the platform 100 of FIG. 1, appropriately programmed, can perform the process 200.

When the host client initiates a conversation space, the host client captures an initial state (202) as initial state data. The initial state data defines the items loaded on the host client. The host client can capture the state by determining the items within the social messaging platform that it is displaying. For example, if the host client is displaying a point within a particular timeline, the initial state data can include an indicator of the timeline and the display point. In another example, if the item includes video, the initial state can include the currently displayed location within the video. Capturing the initial host client state allows client devices that join the conversation space to synchronize with the host client, as described below.

The host client transmits (203) the initial state data to the social messaging platform. The host can transmit the initial state data using any appropriate networking protocol, e.g., HTTP, TCP/IP or UDP. The social messaging platform receives (204) the initial state data using the receive operations corresponding to the protocol used for the host client transmission.

To join the social messaging platform, a client transmits (212) a registration request and the social messaging platform registers (205) the client. The registration process is described further in reference to FIG. 2B.

The social messaging platform transmits (206) the initial state data to the client. The social messaging platform can transmit the initial state data using any appropriate networking protocol, e.g., HTTP, TCP/IP or UDP. The client receives (207) the initial state data using the receive operations corresponding to the protocol used for the social messaging platform transmission.

The client device renders (208) the initial state data. The client can render the initial state data by loading the items loaded on the host client as indicated in the received initial state data. For example, if the initial state data indicates that the host client was viewing a point in a timeline, the client device can load the timeline and scroll to the point indicated in the initial state data.

FIG. 2B is a flow diagram of a process for registering client devices in a platform for providing mirrored streams of content to users of a conversation space using a social messaging platform. For convenience, the process 210 will be described as being performed by a system of one or more computers located in one or more locations. For example, a platform for providing mirrored streams of content, e.g., the platform 100 of FIG. 1, appropriately programmed, can perform the process 210.

A client device transmits (212) a registration request indicating that the user of the client device wishes to join the conversation space. The client device can perform this action, for example, in response to a user providing an indication of a desire to join the conversation space by interacting with user interface presentation data provided by the social messaging platform and displayed on the user device.

The social messaging platform receives (214) the registration request indicating the user wishing to join the conversation space, and the social messaging platform transmits (216) the registration request to the host client running on a host device.

The host client receives (218) the registration request, and the host client evaluates (220) the registration request. The evaluation can be performed by a user interacting with the host client, by the host client evaluating registration criteria, or both.

If the evaluation is performed by a user, the social messaging platform can provide user interface presentation data that is rendered on the client device. The user interface presentation data can indicate an identifier of the user wishing to join and additional optional information, which can include the time the request was made, the location of the user and so on. The user can interact with the interface presentation data to indicate whether the request is approved or not approved.

In implementations where the evaluation includes evaluating registration criteria, the registration criteria can be expressed as rules. The rules can be implemented as conventional rule evaluation techniques. For example, the system can use “if-then” statements, where the “if” portion evaluates information relating to the registration request, and the “then” portion can indicate approval or disapproval. Information relating to the registration request can include an identifier associate with the user, the user's location, if the user account is verified by the social messaging platform, associations of the user, information relating to prior suspensions from the social messaging platform, and so on. Associations of the user can include, for example, indications: (i) that the user works for a particular company, (ii) that the user follows the host, (iii) of other users followed by the user, (iv) that the host follows the user, and (v) of other followers of the user. The criteria can also consider information relating to the conversation space, for example, to limit the number of participants in a given conversation space. Information relating to the conversation can include, for example, the number of users currently participating.

In some implementations, the social messaging platform can evaluate the criteria to make an initial recommendation, provide user interface presentation data to the user indicating the initial recommendation, and provide user interface presentation data that allows the user to make a final determination.

The host transmits (222) the registration response to the social messaging platform. In some implementations, the registration criteria can be evaluated by the social messaging platform instead of by the host, and in such implementations, the registration request is not required to be transmitted to the host client.

The social messaging platform receives (224) the registration response and determines (225) whether the response indicates approval. If the response indicates approval, the social messaging platform registers and transmits (226) an approval indication, which is received by the client (228).

If the response indicates disapproval, the social messaging platform transmits (227) a disapproval message, optionally including a reason for the disapproval, and the client receives (229) the disapproval.

Once a client device has been approved to join the conversation space, the client device will begin receiving content associated with the conversation space, as described below.

FIG. 2C is a flow diagram of an example process 230 for providing mirrored streams of content to users of a conversation space using a social messaging platform. For convenience, the process 230 will be described as being performed by a system of one or more computers located in one or more locations. For example, a platform for providing mirrored streams of content, e.g., the platform 100 of FIG. 1, appropriately programmed, can perform the process 230.

The host receives (231) an indication of user input. As described in reference to FIG. 1, the input can be swipes, presses, long presses, taps, mouse clicks, key presses, voice input, text input and so on, and the input can be received from a user interacting with user interface presentation data provided by the social messaging platform. The input can include an action, e.g., swipe or a press; a location, which can be, for example, a physical location on a screen, a location within a user interface widget that is part of the user interface presentation data or other location indicators; and additional data, e.g., the direction and speed of a swipe or the duration of a press.

The host generates (232) user input command data in response to receiving the user input. The client can, for example, determine from the user input data the command issued by the user of the client device. For example, a press action at a certain location within the user interface presentation data can indicate a request to load the stream of content of a user of the social messaging platform, and a swipe action of a certain length and speed can indicate moving to a location within a stream of content. The host can generate user input command data, for example, in the XML form described in reference to FIG. 1. User input command data can include the action, e.g., switching to a stream of content for a particular user or navigating within a stream of content; and additional data, e.g., the stream of content's user identifier or a location within a stream of content. As noted previously the rendered input command data will require less space than would streamed video.

In some implementations, the host can associate a time location within the host audio stream with the user input command data. For example, the time location can be a duration indicator from a particular reference point, e.g., the last minute marker or the beginning of the host's audio stream, which enables the client device to synchronize the audio data with the user input commands. This time location thus allows clients, upon receiving audio data and user input commands, to render the audio data and user input commands in a way that is temporally consistent with how they were generated at the server.

In some implementations, the duration indicator represents a time location relative to a start of the conversation, e.g., the interval between the initiation of the conversation and the time the user input command data was received as measured using a timer, for example, a timer on the host device. Alternatively or in addition, the duration indicator can represent the actual time the user input command data was received, for example, as retrieved using the Network Time Protocol (NTP) from an NTP server.

In some implementations, the duration indicator can instead be generated by the platform, as described below.

The host provides (234) the user input command data to the social messaging platform, for example, using a networking protocol as described in reference to FIG. 1, and in step 240, the social messaging platform receives the user input command data provided by the host.

The social messaging platform provides (245) the user input command data to user devices registered with the conversation space, and as noted above, the social messaging platform can also provide other information, e.g., messages. Registration was described in reference to FIG. 2B. In some implementations, when the host device has not associated a duration indicator, before providing the user input command data to user devices, the social messaging platform can generate a duration indicator and associate it with the user input command data. As described with reference duration indicators generated on the host device, the duration indicator can be, for example, an absolute time provided by an NTP server or by a clock on or accessible to the social messaging platform. The duration indicator can also be a time provided by a clock on or accessible to the social messaging platform that is relative to a base a point in time, e.g., the most recent time the clock was reset, provided the base point in time does not change during the duration of the conversation space.

In cases where a client has not received previous user input command data, e.g., the client joined the conversation space during the conversation, the social messaging platform can provides all user input command data provided by the host up to the current time. The social messaging platform can provide the user input command data in the order that it was received by the social messaging platform. This operation allows a client to catch up to the current point in the conversation space.

The client receives (250) the user input command, and the client executes (255) the user input command. To execute the user input command, the client determines, from information in the user input command, the action to be performed, any data associated with the action, as well as a time to execute the command so that it is synchronized with audio received from the host. The client then executes the action on the client device by emulating the actions the client would have taken if the action were instigated by a user of the client device interacting with the social messaging platform through user interface presentation data produced by the client. In some implementations, the client can delay executing the user command, e.g., to synchronize the execution of the user input command with audio data produced by the host device, as described in reference to FIG. 2D. Further, the client can receive other content, e.g., messages, received from the social messaging platform.

FIG. 2D is a flow diagram of a process for providing mirrored streams of content with mixed audio streams in a platform for providing mirrored streams of content to users of a conversation space using a social messaging platform. A mixed audio stream can include audio information received from the host, one or more clients, or both. A mixed audio stream can augment the user experience provided by a mirrored stream of content, for example, by allowing participants in a conversation space to discuss the information displayed on a stream of content.

For convenience, the process 260 will be described as being performed by a system of one or more computers located in one or more locations. For example, a platform for providing mirrored streams of content, e.g., the platform 100 of FIG. 1, appropriately programmed, can perform the process 260.

The process 260 can begin identically to the process 230 described with reference to FIG. 2C. Specifically, the host can receive user input 231, generate user input command data 232, optionally containing a duration indicator, and provide user input command data 234; the social messaging platform can receive the user input command data 240. As described in reference to FIG. 2C, the host or the social messaging platform can associate (240) a duration indicator with the user input command data.

Audio data is transmitted (261) to the social messaging platform by either or both of a host and client device(s). Audio data can include audio spoken by a user of the host device or a client device.

In some implementations, before transmitting the audio data, the host device associates a time location, e.g., a duration indicator, with the audio data, and associates a source indicator with the audio data. As described above, in some implementations, the source indicator can by default specify that the source is a client device, and be adjusted by the host device to a value associated with a host.

The social messaging platform receives (262) the audio data. Optionally, the social messaging platform can associate a time location, e.g., a duration indicator with the audio data, e.g., in cases when the host device has not associated a duration indicator. For example, the duration indicator can reflect the interval between the initiation of the conversation and the time the audio data is received. Alternatively or in addition, the duration indicator can reflect the actual time the user input command data was received, for example, as retrieved using NTP from an NTP server.

The social messaging platform produces (264) a mixed audio stream. The social messaging platform can merge the audio data into a single mixed audio stream using conventional audio merging technologies, for example, by summing the signals encoded by the audio data. In implementations in which a source indicator is present, the social messaging platform can apply a disjunction operation on the source indicators associated with the various items of audio data—that is, the source indicator for the mixed audio data is set to the host value if and only if any of the items of audio data have a source indicator set to the host value.

Note that while steps 261 and 262 are illustrated as being performed after steps 231, 232, 234 and 240—that is, the user input command data is received before the audio data—steps 261 and 262 can also be performed before steps 231, 232, 234 and 240—that is, the audio data can be received before the user input command data is generated—at the same time as steps 231, 232, 234 and 240 and the execution of the steps can be interleaved.

The social messaging platform transmits (266) the mixed audio stream with user input command data, and the mixed audio stream with user input command data is received (268) by the host, by one or more clients, or by both. In cases where user input command data has been received, but no mixed audio data has been received, transmission step 266 will include only user input command data as illustrated in FIG. 2C step 245. In cases where mixed audio data has been received, but no user input command data has been received, the transmission step will include only mixed audio data. This case can occur, for example, when there is discussion among participants in a conversation space during a time interval but no updates to the mirrored stream of content are made during that period. Note that while the mixed audio stream and user input command data are illustrated as being transmitted in the same communication stream, the mixed audio stream and user input command data can be transmitted in separate streams and assembled at the one or more clients.

Optionally, in cases where duration indicators are included with the audio data received in step 262 and with the user input command data received in step 240, the social message platform can transmit the duration indicators in association with the corresponding content—that is, the element of mixed audio data or user input command data is associated with its duration indicator, and both the element and the duration indicator are transmitted.

As illustrated in FIG. 2D, steps 255 and 270 can be executed in various combinations. Specifically, there can be three cases: (i) the client device receives only mixed audio data, (ii) the client receives only user input command data, and (iii) the client device receives both mixed audio data and user input command data.

In case (i), the host and/or client device(s) execute only step 270 by using conventional audio playback techniques to render the mixed audio data. There are no user input commands in this case.

In case (ii), the client device(s) can execute the user input commands 255, as described previously in reference to FIG. 2B. There is no mixed audio data in this case. The host would typically not encounter this case since it is the source of user input commands, and therefore will not receive the commands. The client device can execute the user input command in the context of the presentation of content received from the social messaging platform by the client device. The content can include, for example, message posts, images, videos, audio, emojis, stickers, “likes,” etc., and the context can include which content is present of the device, the location of each item of content on the screen, and so on.

In case (iii), the client device receives both mixed audio data and user input command data. As described above, the host would not encounter this case since it is the source of user input commands, and therefore will not receive the commands.

First, the client device determines whether a source indicator is present, and if so, whether it is set to the host value. If a source indicator is not present, or is not set to the host value, then the client device executes steps 255 and 270 as described above.

If a source indicator is present and is set to the host value, i.e., the client device has received both user input command data and mixed audio data that includes audio data from the host device, then the client device synchronizes the user input commands with the mixed audio data. This step allows the client device to execute the command and play the corresponding audio from the host device approximately at the relative times they were created at the host, where approximately at the same time can mean within a short interval, e.g., 1 second.

The client device determines (269) the time location for the user input command to be executed in the mixed audio stream, and executes the user input command. In some implementations, the client device can execute the user input command at the later of (i) the time location relative to the mixed audio stream, or (ii) when the second user device receives the user input command data. The client device first compares the time location, e.g., the duration indicator, for the user input command data with the duration indicator for the mixed audio data. If the duration indicator for the user input command data equals the duration indicator for the mixed audio data, the client device both renders the mixed audio data and performs the user input commands without introducing any delays. The client device can execute the user input command in the context of the presentation of content received from the social messaging platform by the client device.

If the duration indicator for the user input command data is earlier than the duration indicator for the mixed audio data, the client device executes the user input commands immediately, then delays for an amount of time corresponding to the difference between the two duration indicators before rendering the mixed audio data. For example, if the duration indicator, expressed in seconds, for the user input command data is 1000 and the duration indicator for the mixed audio data is 1002, then the client device would execute the user input commands, delay 2 seconds, then begin rendering the mixed audio data.

If the duration indicator for the user input command data is later than the duration indicator for the mixed audio data, the client device begins rendering the mixed audio data, then delays for an amount of time corresponding to the difference between the two duration indicators before executing the user input commands. For example, if the duration indicator, expressed in seconds, for the user input command data is 1005 and the duration indicator for the mixed audio data is 1000, then the client device would begin rendering the mixed audio data, delay 5 seconds, then execute the user input commands. Note that, in this example, if the duration of the mixed audio data is longer than 5 seconds, the user input commands will begin executing while the mixed audio data is still being rendered.

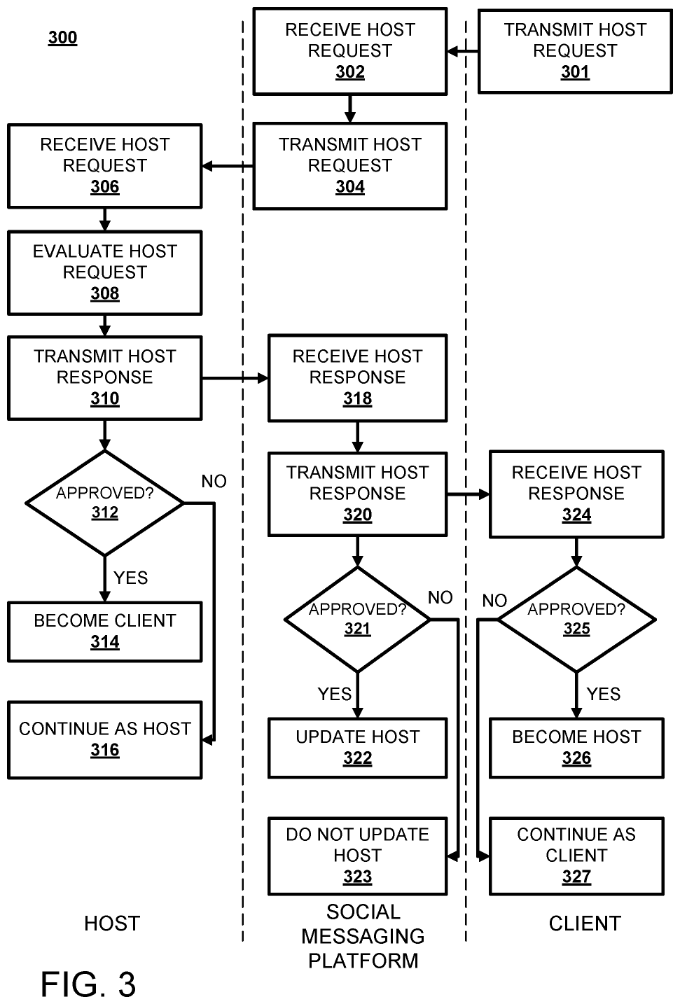

FIG. 3 is a flow diagram of a process for altering the host in a platform for providing mirrored streams of content to users of a conversation space using a social messaging platform. For convenience, the process 300 will be described as being performed by a system of one or more computers located in one or more locations. For example, a platform for providing mirrored streams of content, e.g., the platform 100 of FIG. 1, appropriately programmed, can perform the process 300.

A client transmits (301) a request to become the host of a conversation space. The client can perform this action, for example, in response to a user providing an indication of a desire to host the conversation space by interacting with user interface presentation data provided by the social messaging platform and displayed on the user device.

The social messaging platform receives (302) the client's request to become host, and transmits (304) the request to the device currently serving as the host of the conversation space.

The host receives (306) the request, and the host evaluates (308) the request. The evaluation can be performed either by a user interacting with the host device, by evaluating host determination criteria, or both.

If the evaluation is performed by a user interacting with the host device, the social messaging platform can provide user interface presentation data that is rendered on the host device. The user interface presentation data can indicate an identifier of the user wishing to become the host and additional optional information, e.g., the time the request was made, the location of the user the role of the user. The user of the host device can interact with the interface presentation data to indicate whether the request is approved or not approved.

In implementations where the evaluation includes evaluating host determination criteria, the registration criteria can be expressed as rules. The rules can be implemented as conventional rule evaluation techniques. For example, the system can use “if-then” statements, where the “if” portion evaluates information relating to the hosting request, and the “then” portion can indicate approval or disapproval. Information relating to the hosting request can include, for example, an identifier that describes the user, the user's location and associations of the user. Associations of the user can include a role in a particular company, for example, executive, manager and individual contributor.

The host client transmits (310) the request to the social messaging platform, and continues to decision step 312.

If the request was approved (312, 314), the host yields (314) the hosting role and begins operating as a client; if the request was not approved, the host continues (316) in that role.

The social messaging platform receives (318) the response to the host request, and transmits (320) the host response to the client.

If the request was approved (321, 322), the social messaging platform updates (322) the host designation to reflect that the client has assumed, or will soon assume, the role of host, and the former host client is now participating as a client. If the request was not approved, the social messaging platform does not update (323) the host designation.

The client receives (324) the response to its request to become host. If the request was approved (325, 326), the client assumes (326) the host role; if the request was not approved, the client continues (327) as a client.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
receiving, by a host client on a first user device, user input on a user interface of the first user device, wherein the host client has joined a conversation space provided by a social messaging platform;
displaying on the first user device, by the host client, first presentation data that is generated by the host client in response to the user input;
generating, from the user input, by the host client, first data representing a user input command to be executed by a plurality of other user devices that have joined the conversation space;
providing, by the first user device, the first data representing the user input command to the social messaging platform;
providing, by the social messaging platform, second data representing the user input command to the plurality of other user devices that have joined the conversation space;
receiving, by a second client on a second user device of the plurality of other user devices, the second data representing the user input command and a mixed audio stream generated from a plurality of audio signals received from a plurality of the user devices in the conversation space;
rendering, by the second client, and outputting on the second user device, the mixed audio stream; and
executing, by the second user device, the user input command at the later of (i) a location in the audio data that corresponds to a location in the mixed audio stream at which the user input command was input at the first user device, or (ii) when the second user device receives the user input command.

Embodiment 2 is the method of embodiment 1 wherein the second user device determines the location in the audio data that corresponds to the location in the mixed audio stream at which the user input command was input at the first user device using a duration indicator received from the social messaging platform.

Embodiment 3 is the method of any one of embodiments 1-2 wherein the duration indicator specifies an interval between an initiation of the conversation space and a time the user input command data is received by the social messaging platform.

Embodiment 4 is the method of any one of embodiments 1-2 wherein the duration indicator includes an absolute time.

Embodiment 5 is the method of any one of embodiments 1-4, wherein all clients of the user devices that have joined the conversation space execute the user input command to synchronize presentation of data that is presented by the first client on the first user device.

Embodiment 6 is the method of any one of embodiments 1-5, wherein the user input command represents a scroll, a swipe, a tap, or text input.

Embodiment 7 is the method of any one of embodiments 1-6, wherein the first data representing the user input command represents a scroll distance and speed.

Embodiment 8 is the method of any one of embodiments 1-7, further comprising: providing, by the social messaging platform, a mixed audio stream comprising audio signals received from the user devices in the conversation space while synchronizing presentation of data to data presented by the first user device.

Embodiment 9 is the method of any one of embodiments 1-8, further comprising:
receiving, by the social messaging platform, a request from a client to host a conversation space;
evaluating, by the social messaging platform, criteria related to the request from the client to host the conversation space; and
in response to determining that the criteria are satisfied, assigning, by the social messaging platform, the client as the host of the conversation space.

Embodiment 10 is the method of any one of embodiments 1-9, further comprising:
receiving, by the social messaging platform, from a client device, a request to join a conversation space;
evaluating, by the social messaging platform, criteria related to the request from the client device to join the conversation space; and
in response to determining that the criteria are satisfied, joining, by the social messaging platform, the client device to the conversation space.

Embodiment 11 is a system comprising one or more computers and one or more storage devices storing instructions that when executed by the one or more computers cause the one or more computers to perform the respective operations of the methods of any one of embodiments 1-10.

Embodiment 12 is one or more non-transitory computer-readable storage media storing instructions that when executed by one or more computers cause the one or more computers to perform the respective operations of the methods of any one of embodiments 1-10.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving, by a host client on a first user device, user input on a user interface of the first user device, wherein the host client is participating in a conversation space provided by a social messaging platform and providing a host audio stream for the conversation space to the social messaging platform, wherein the user input is made at a time location relative to the conversation space;
generating, from the user input by the host client, first command data representing a user input command corresponding to the user input, the user input command to be executed by a plurality of respective clients being used by users on other user devices that have joined the conversation space, wherein the first command data associates the user input command with a time location in the host audio stream;
providing, by the first user device, the first command data to the social messaging platform;
providing, by the social messaging platform, second command data representing the user input command to the respective clients on the plurality of other user devices that have joined the conversation space;
receiving, from the social messaging platform, by a second client on a second user device of the plurality of other user devices, (i) the second command data representing the user input command and (ii) a mixed audio stream generated from one or more audio signals received from one or more user devices in the conversation space, the mixed audio stream including audio from the host audio stream;
determining, by the second user device, a time location relative to the mixed audio stream that corresponds to the time location relative to the audio space;
rendering, by the second client, the mixed audio stream, and outputting the rendered mixed audio stream on the second user device; and
executing, by the second user device, the user input command at the later of (i) the time location relative to the mixed audio stream, or (ii) when the second user device receives the second data.

2. The method of claim 1, wherein the user input command represents a scroll, a swipe, a tap, or text input on a presentation of content.

3. The method of claim 1, further comprising:
sending, by the second user device, to a social messaging platform, a request to join a conversation space;
sending, by the social messaging platform to the host client, an indication of the request;
in response to receiving, by the host client, the indication of the request, providing to the social messaging platform an indication of approval of the request; and
in response to receiving, by the social messaging platform, the indication of approval, providing, by the social messaging platform to the second device, user input commands and mixed audio streams.

4. The method of claim 1, wherein the second user device determines the location in the mixed audio stream using a duration indicator received from the social messaging platform, and wherein the duration indicator is created by the host client or by a social messaging platform.

5. The method of claim 4, wherein the duration indicator specifies a time relative to a beginning of the conversation or to an absolute time.

6. The method of claim 1, wherein the first data representing the user input command represents a scroll distance and speed.

7. A system comprising one or more computers and one or more storage devices storing instructions that when executed by the one or more computers cause the one or more computers to perform operations comprising:
receiving, by a social messaging platform from a first user device, user input entered on a user interface of the first user device, wherein a host client is participating in a conversation space provided by the social messaging platform and providing a host audio stream for the conversation space to the social messaging platform, wherein the user input is made at a time location relative to the conversation space;
receiving, by the social messaging platform from the first user device, first command data generated from the user input by the host client, the first command data representing a user input command corresponding to the user input, the user input command to be executed by a plurality of respective clients being used by users on other user devices that have joined the conversation space, wherein the first command data associates the user input command with a time location in the host audio stream; and
providing, by the social messaging platform to a second user device, that has joined the conversation space, (i) second command data that represents the user input command, and (ii) a mixed audio stream generated from one or more audio signals received from one or more user devices that have joined the conversation space, the mixed audio stream including audio from the host audio stream, thereby causing the second user device to:
render the mixed audio stream; and
execute the user input command at the later of (i) the time location relative to the mixed audio stream, or (ii) when the second user device receives the second command data.

8. The system of claim 7, wherein the user input command represents a scroll, a swipe, a tap, or text input on a presentation of content.

9. The system of claim 8, wherein content within the presentation of content includes one or more of social messaging posts, images, videos, audio, emojis, likes and stickers.

10. The system of claim 7, further comprising:
receiving, by the social messaging platform from the second user device, a request to join a conversation space;
sending, by the social messaging platform to the host client, an indication of the request;
receiving, by the social messaging platform and from the host client, an indication of approval of the request; and
in response to receiving, by the social messaging platform, the indication of approval, providing, by the social messaging platform to the second device, user input commands and mixed audio streams.

11. The system of claim 7, wherein the social messaging platform provides a duration indicator to the second user device, thereby causing the second user device to determine the location in the mixed audio stream using the duration indicator.

12. The system of claim 11, wherein the duration indicator is received by the social messaging platform from the host client.

13. The system of claim 11, wherein the duration indication is created by the social messaging platform.

14. The system of claim 11, wherein the duration indicator specifies a time relative to a beginning of the conversation.

15. The system of claim 11, wherein the duration indicator specifies an absolute time.

16. The system of claim 7, wherein the first data representing the user input command represents a scroll distance and speed.

17. One or more non-transitory computer-readable storage media storing instructions that when executed by one or more computers cause the one or more computers to perform operations comprising:
receiving, by a social messaging platform from a first user device, user input entered on a user interface of the first user device, wherein a host client is participating in a conversation space provided by the social messaging platform and providing a host audio stream for the conversation space to the social messaging platform, wherein the user input is made at a time location relative to the conversation space;
receiving, by the social messaging platform from the first user device, first command data generated from the user input by the host client, the first command data representing a user input command corresponding to the user input, the user input command to be executed by a plurality of respective clients being used by users on other user devices that have joined the conversation space, wherein the first command data associates the user input command with a time location in the host audio stream; and
providing, by the social messaging platform to a second user device, that has joined the conversation space, (i) second command data that represents the user input command, and (ii) a mixed audio stream generated from one or more audio signals received from one or more user devices that have joined the conversation space, the mixed audio stream including audio from the host audio stream, thereby causing the second user device to:
render the mixed audio stream; and
execute the user input command at the later of (i) the time location relative to the mixed audio stream, or (ii) when the second user device receives the second command data.

18. The one or more non-transitory computer-readable storage media of claim 17, further comprising:
receiving, by the social messaging platform from the second user device, a request to join a conversation space;
sending, by the social messaging platform to the host client, an indication of the request;
receiving, by the social messaging platform and from the host client, an indication of approval of the request; and
in response to receiving, by the social messaging platform, the indication of approval, providing, by the social messaging platform to the second device, user input commands and mixed audio streams.

19. The one or more non-transitory computer-readable storage media of claim 17, wherein the social messaging platform provides a duration indicator to the second user device, thereby causing the second user device to determine the location in the mixed audio stream using the duration indicator.

20. The one or more non-transitory computer-readable storage media of claim 19, wherein the duration indicator specifies a time relative to a beginning of the conversation or an absolute time.
